(19) United States
(12) Patent Application Publication
(10) Pub. No.: US 2025/0283520 A1
(43) Pub. Date: Sep. 11, 2025

(54) VIBRATION ISOLATOR HAVING A COIL SPRING AND AN ACTUATOR

(71) Applicant: INTEGRATED DYNAMICS ENGINEERING GMBH, Raunheim (DE)

(72) Inventors: Johannes HARTGERS, Mainz (DE); Arndt EVERS, Oestrich-Winkel (DE); Simon SCHADT, Wiesbaden (DE)

(21) Appl. No.: 18/860,154

(22) PCT Filed: May 3, 2023
(86) PCT No.: PCT/EP2023/061704

§ 371 Date: Oct. 25, 2024

(30) Foreign Application Priority Data
May 5, 2022 (DE) 10 2022 111 155.5

(51) Int. Cl. F16F 15/03

(52) U.S. Cl. CPC F16F 15/03; F16F 2234/02; F16F 2238/026

(57) ABSTRACT

The invention generally relates to an active vibration isolator having a coil spring which acts in a vertical direction. The invention also relates to a method for actively damping vibrations of a mounted load, for example a mounted machine, system or device.

For this purpose, there is provided a vibration isolator having an inner housing with a cavity for receiving and holding a coil spring which is arranged in the cavity of the inner housing and acts in a vertical direction, and also an outer housing at least partially surrounding the inner housing. Between the inner housing and the outer housing there is arranged an actuator which acts in a vertical direction.

### BACKGROUND

The present disclosure generally relates to an active vibration isolator comprising a coil spring that acts in a vertical direction. More particularly, the present disclosure relates to a vibration isolator that can be used in a stationary vibration isolation system for mounting machines, systems or devices, in particular in the semiconductor industry, such as systems or devices in the field of lithography, optical inspection devices or wafer handling devices. Furthermore, the present disclosure also relates to a method for actively damping vibrations of a mounted load, for example a mounted machine, system or device.

Vibration isolation systems comprising a mechanical spring, for example a coil spring, are well known. In such a system, a load to be isolated from the ground, for example a system in the field of lithography, is mounted on three or more vibration isolators that are effective in at least a vertical direction. Mechanical coil springs already enable passive vibration isolation in a very simple way, in particular also in the case of relatively large or heavy loads. Vibration isolation can be achieved above the natural frequency of the spring-mass system.

The isolating effect of such vibration isolation systems, especially when they are used for mounting sensitive machines, for example in the semiconductor industry, can be improved by implementing the vibration isolation system as an active vibration isolation system.

The mechanical spring systems used are designed for the weight of the load to be mounted. This is desirable because a mechanical spring will no longer behave linearly in the load limit range and the damping properties will therefore become less favorable. Moreover, the vibration isolator might even be damaged.

Since the deflection of a coil spring behaves essentially linear to the applied force in the intended load range, it will be appreciated that the level of the vibration-isolated load changes with its weight.

In order to compensate for variations in the isolated load or an uneven force distribution, it has been known to provide such mechanical spring systems with a height correction. This can be achieved quite easily, for example using a height-adjustable spring plate allowing the vibration isolation system to be adjusted in the rest position. Such a mechanical vibration isolator is described in Applicant's document EP 2 750 736 A1.

However, when adjusting the height of such mechanical spring systems, torques may arise in certain cases, which can result in a horizontal force. This horizontal force component usually leads to a horizontal displacement of the vibration-isolated load or in the vibration isolator itself, which is undesirable. Horizontal displacement is particularly disadvantageous in active vibration isolation systems, as this causes the opposing components of non-contact actuators to be offset relative to one another.

In a magnetic actuator, for example, the gap dimensions between the magnets involved might change, which can have a negative impact on performance. However, the magnets may even be damaged. To prevent this, the actuator is designed as an individual component and is arranged spatially separated from the vibration isolator in order to be able to reliably rule out any damage, for example when adjusting the mechanical spring system.

Another spring system, based on a pneumatic spring, is therefore proposed in document EP 3 181 944 A1. However, such a pneumatic isolation system can have other drawbacks, for example if the load to be isolated represents a high moving mass and/or a high acceleration of the moving mass is exerted on the system. In this case, high forces are required, which in the case of pneumatic springs require a corresponding installation space. However, the structure and operation of such a pneumatic spring have to be regarded as more complex than that of a coil spring.

What is desirable, therefore, is a vibration isolator that does not exhibit these drawbacks.

The vibration isolator should feature an installation space as small as possible in order to be capable of being used variably.

The vibration isolator should also permit to be used for rather heavy loads, in particular for loads weighing 500 kg or more, for example 1,000 kg or more.

The inventors have taken on this task.

This task is solved in a surprisingly simple way by a vibration isolator and a method for damping vibrations according to any one of the independent claims. Embodiments and refinements of the present disclosure will be apparent from the respective dependent claims.

The subject-matter of the present disclosure therefore encompasses a vibration isolator comprising
an inner housing with a cavity for receiving and holding a coil spring which is arranged in the cavity of the inner housing and is acting in a vertical direction,
an outer housing at least partially surrounding the inner housing, and an actuator acting in a vertical direction, which is arranged at least partially between the inner housing and the outer housing.

The vibration isolator may form part of a vibration isolation system that is set up stationarily and can be used, for example, for mounting equipment in the semiconductor industry.

Such a vibration isolation system can, for example, comprise a vibration-isolated table or frame on which the respective devices are mounted. In the context of the present present disclosure, “horizontal” and “vertical” are understood to relate to the main direction of the vibration isolator in its installed state.

With regard to the coil spring, the vertical direction therefore corresponds to the orientation of the center axis of the coil spring in the operating state, i.e. the axial direction. The vibration isolator is effective in this direction.

In order to couple the vibration isolator to the ground or floor, the outer housing can be designed with appropriate fastening means to create a firm connection to the floor. For example, screw connections may be provided for this purpose in order to firmly and detachably connect the vibration isolator to appropriate mounts on the floor, for example.

The outer housing can accommodate the inner housing in its interior, at least sections thereof. According to an embodiment of the present disclosure, the outer housing can surround the inner housing along its outer wall, so that the inner wall of the outer housing and the outer wall of the inner housing face each other.

The outer and inner housings may be cylindrical, which can be beneficial in terms of even force distribution and isolation. In this case, the outer and inner housings and the coil spring will be arranged coaxially to each other.

In an embodiment of the present disclosure, the outer housing and the inner housing are moreover rigidly coupled to one another in the horizontal direction. In order to enable the movement required for vibration isolation, the inner housing may be movable within the outer housing in the vertical direction. In other words, the inner housing with the coil spring can move in the axial or vertical direction relative to the outer housing, but is rigidly coupled to the outer housing in the radial or horizontal direction.

The rigid coupling of the inner housing in the horizontal direction may be provided by at least one spring element, for example at least one leaf spring, which can be connected in parallel to the actuator. The leaf spring can be arranged in the working space of the vibration isolator and connect the inner housing to the outer housing.

In an embodiment, the vibration isolator comprises at least two leaf springs that are spaced apart from one another in the axial direction. This is particularly effective in counteracting tilting of the inner housing relative to the outer housing and ensures a rigid connection in the horizontal direction.

The leaf spring may form part of a leaf spring package in this case. For example, segmented leaf springs made up of ring segments are conceivable. Another embodiment provides two leaf spring packages arranged axially spaced apart from each other, which are arranged approximately in the vicinity of the end face of the inner and outer housings.

This makes it possible to arrange the leaf springs in an exchangeable way. This allows to easily adjust the natural frequency of the vibration isolator by exchanging the spring packages, so that adaptation to different load situations is possible. In particular, a natural frequency of more than 5 Hz can be achieved in order to obtain short settling times.

In an embodiment of the present disclosure, the coil spring is coupled to the inner housing in a mechanically rigid manner in the horizontal direction and therefore isolates in the vertical direction. The inner housing can be provided with appropriate means to receive and hold the coil spring, for example spring plates, which allow the coil spring to be firmly seated in the horizontal and vertical directions.

According to the present disclosure, an actuator acting in the vertical direction is provided, which can be arranged in the working space of the vibration isolator. This enables a particularly uniform introduction of force into the vibration isolator with optimal utilization of space.

In another embodiment of the present disclosure, the actuator comes in the form of a magnetic actuator, comprising at least one coil and one magnet, which form a magnet-coil pair. The coil and the magnet can be arranged between the inner housing and the outer housing, for which purpose a corresponding cavity or working space can be provided. For example, the working space may comprise recesses on the inner wall of the outer housing and/or recesses on the outer wall of the inner housing.

Thus, the actuator provides for additional vibration isolation in the vertical direction, in addition to the coil spring. The actuator is used in particular for active vibration isolation. The vibration isolator according to the present disclosure can therefore also be referred to as an active vibration isolator.

In an embodiment, the at least one magnet-coil pair surrounds the coil spring, at least sections thereof. In other words, the coil and/or the magnet are arranged at least partially around the coil spring.

In another embodiment, the at least one magnet-coil pair is ring-shaped or is based on ring-shaped segments. In this way, the coil spring can be partially or for example completely surrounded. This provides for a particularly even introduction of force through the actuator into the vibration isolator. In particular, this allows to prevent the actuator from causing a tilting movement of the inner housing as a result of an uneven, one-sided force application.

In an embodiment, the at least one coil of the actuator extends around the inner housing and is therefore arranged on the outer wall of the inner housing. The at least one coil may be pressed onto or glued to the inner housing, for example. The associated magnet, in particular a permanent magnet, can be associated with the outer housing and extend on the inner wall thereof. It may also be glued thereto.

In an embodiment, the magnet and the associated coil are arranged opposite each other, with a gap between the magnet and the coil.

Due to the rigid coupling between the inner and outer housings in the horizontal direction, this gap can be designed to be particularly narrow and, for example, can have a width of less than 5 mm in the radial direction, for example less than 1 mm, and for instance less than 0.5 mm. On the one hand, this makes it possible to design the working space to be correspondingly small, so that the vibration isolator can be kept compact overall. On the other hand, comparatively high forces can be generated.

In other embodiments, reverse arrangements can also be provided, i.e. an arrangement of the magnet on the outer wall of the inner housing and of the coil on the inner wall of the outer housing.

According to an embodiment, the vibration isolator comprises a plurality of actuators, for example magnetic actuators, which are arranged next to one another in the axial direction. In one embodiment, the vibration isolator comprises at least two or, for instance, three or even more actuators, in particular magnetic actuators, that are arranged next to one another. This allows higher forces to be generated with a compact installation space.

In an embodiment, current flows in opposite directions through adjacent magnet-coil pairs. For this purpose, the winding direction of adjacent coils and the magnetization direction of the magnets are for example designed to alternate between the adjacent magnet-coil pairs.

In order to provide for a uniform application of force over the length with an odd number of magnet-coil pairs, for example three magnet-coil pairs, the middle magnet-coil pair may be dimensioned larger than the outer magnet-coil pairs in order to allow for a higher application of force with the same current. This configuration reduces the saturation of the magnetic field between the different sets of magnets, which ultimately leads to a higher magnetic inductance (B) in the gap to the coil.

For example, for this purpose, the middle magnet-coil pair may have twice the number of coil windings compared to the two outer magnet-coil pairs.

The outer magnet-coil pairs may have the same number of coil windings in this case. In this way, it is particularly easy to generate two magnetic fields lying next to each other in the axial direction, which can be used to effect a vertical movement of the inner housing relative to the outer housing.

In the axial direction, adjacent magnet-coil pairs may have a spacing of approximately 1 to 5 mm to each other, and a magnetic shield may be provided therebetween.

In an embodiment, the vibration isolator further comprises a for example elongated insert which serves to accommodate the load. This insert may protrude into the coil spring, at least partially. At the upper end, the insert may be firmly connected to the inner housing and comprise an upper seat for receiving the coil spring, for example an upper spring plate. In another embodiment, the insert may be designed as part of the inner housing.

In the area protruding into the coil spring, the insert may be designed at least partially with an upwardly open cavity which can be used to accommodate a load bearing means. In the lower portion of the cavity, the load bearing means may be firmly coupled to a base portion of the insert in the axial and radial directions. The load bearing means is therefore retained at the base of the insert, while in the upper portion it can be arranged freely inside the cavity, so that movement is possible in the radial and horizontal directions.

The load bearing means may be designed particularly favorably as a bending rod or buckling pendulum and can be connected at its upper end to a load to be isolated. Suitable supports may can be provided for this purpose. A force acting in a horizontal direction on the load to be isolated can therefore be absorbed by the load bearing means.

According to a further aspect, the present disclosure encompasses a method for isolating a load to be supported, which uses at least one vibration isolator according to the present disclosure as described above.

The method may provide for sensors to be arranged on the load to be isolated and/or on the floor, and at least one actuator of the vibration isolator can then be controlled via a control loop, which actively counteracts any vibrations that might occur. The sensor may come in the form of a motion or acceleration sensor, for example.

According to yet another aspect, the present disclosure encompasses a device, in particular a lithography device or system, an optical inspection device, a system or device for handling wafers or substrates, which device comprises at least one vibration isolator as described above for vibration isolation. In various embodiments, such devices may comprise at least three such vibration isolators for a three-point mounting.

It is also conceivable and possible to operate two such vibration isolators in combination, in which case these two vibration isolators are arranged rotated by 90° relative to each other, so that active vibration isolation can be enabled both in a first, for example vertical direction, and a second, for example horizontal direction.

The vibration isolator according to the present disclosure is characterized by a small installation space and can therefore be used in a very variable manner.

In addition, the vibration isolator according to the present disclosure can also be used for rather high loads, in particular for loads having a weight of 500 kg or more, for example 1,000 kg or more, or even 1,500 kg or more.

Further details of the present disclosure will be apparent from the description of the illustrated embodiments and the appended claims.

### BRIEF DESCRIPTION OF THE DRAWINGS

FIG. 1 is a cross-sectional view showing one embodiment of a vibration isolator according to the present disclosure;

FIG. 2 is a perspective view of the vibration isolator of FIG. 1;

FIG. 3 is a schematic side elevational view of a vibration isolation system;

FIG. 4 is a perspective cross-sectional view of the vibration isolator of FIG. 2;

FIG. 5 is a cross-sectional view showing the side wall of the vibration isolator according to the present disclosure; and

FIG. 6 shows a magnetic field arising during operation in the area of the side wall of FIG. 5.

### DETAILED DESCRIPTION

In the following detailed description, the same reference numerals designate substantially similar parts in or on those embodiments, for the sake of clarity. However, to better illustrate the present disclosure, the embodiments shown in the figures are not always drawn to scale.

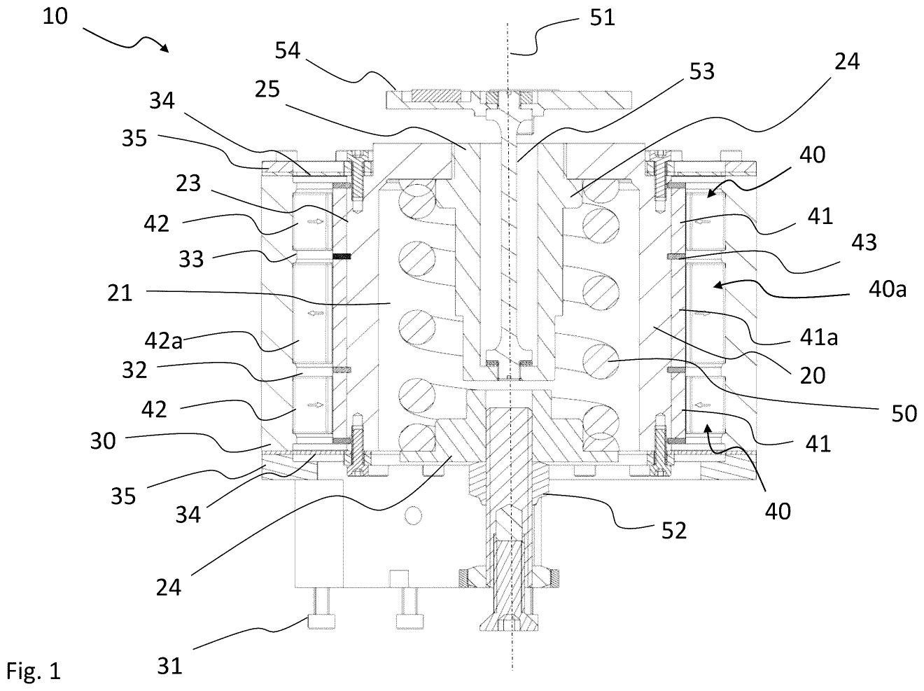

FIG. 1 is a cross-sectional view showing an embodiment of a vibration isolator 10 according to the present disclosure.

Here, the illustrated vibration isolator 10 comprises
an inner housing 20 with a cavity 21 for receiving and holding a coil spring 50 which is arranged in the cavity 21 of the inner housing 20 and is acting in a vertical direction,
an outer housing 30 at least partially surrounding the inner housing 20, and an actuator 40 that is acting in a vertical direction, which is arranged between the inner housing 20 and the outer housing 30.

The vibration isolator 10 may form part of a vibration isolation system 1 which is installed stationarily and which can be used, for example, for mounting devices of the semiconductor industry.

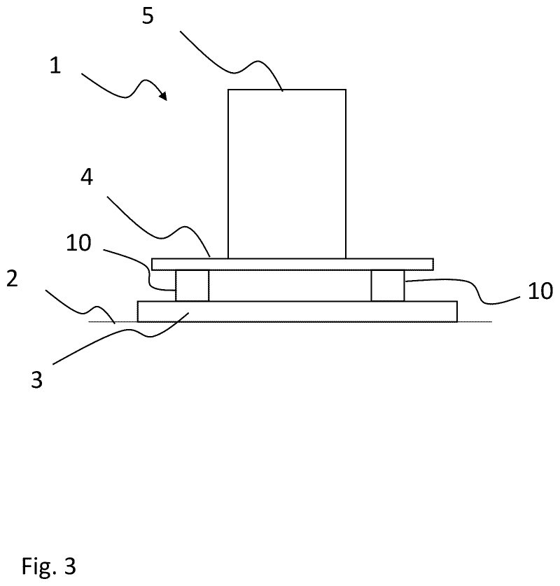

For example, such a vibration isolation system 1 may comprise a table 4 or frame which is mounted for vibration isolation and on which the respective devices are supported, e.g. a scanning electron microscope 5. FIG. 3 shows a purely schematic side elevational view of a vibration isolation system 1. The table 4 and a device 5 located thereon as a load to be mounted can be isolated from the floor 2 using the vibration isolators 10. In this embodiment, a total of four such vibration isolators 10 are provided.

In order to connect the vibration isolator 10 to the floor, the outer housing 30 may be implemented with appropriate fastening means to produce a firm connection to the floor or to a support panel 3. For this purpose, screw connections 31 may be provided, for example, in order to firmly and detachably connect the vibration isolator to appropriate mounts, for example.

The outer housing 30 is capable of accommodating the inner housing 20 in its interior at least partially or sections thereof, and for this purpose it is provided with a cavity, which will also be referred to as a working space 32 below.

In the illustrated embodiment, the outer housing 30 surrounds the inner housing 20 almost completely, so that the inner wall 33 of the outer housing 30 and the outer wall 23 of the inner housing 20 face each other. It is not absolutely necessary for the outer housing 30 to completely surround the inner housing 20 axially. For example, it is also possible for the inner housing 20 to protrude, which, however, might lead to a reduction in stability, in particular in the horizontal direction.

In this embodiment, the outer and inner housings are cylindrical, which facilitatesan even load absorption and damping and has proven to be suitable. This makes it possible to arrange the outer and inner housings 20, 30 and the coil spring 50 coaxially to the center line 51, which is very useful for even weight distribution and homogeneous load distribution.

The outer housing 30 and the inner housing 20 are coupled to each other in a mechanically rigid fashion in the horizontal direction.

In order to enable the movement required for vibration isolation, the inner housing 20 is mounted inside the outer housing 30 in a way so as to be movable in the vertical direction. In other words, the inner housing 20 with the coil spring 50 can move in the axial, i.e. vertical, direction relative to the outer housing 30.

In this embodiment, the rigid coupling of the inner housing 20 in the horizontal direction is achieved by two leaf spring packages 34 as vertically acting spring elements, which are connected in parallel to the actuator 40. The leaf spring packages 34 are arranged in the working space 32 of the vibration isolator 10 and couple the inner housing 20 to the outer housing 30.

In this embodiment, the vibration isolator 10 comprises two leaf spring assemblies 34 which are spaced apart from one another in the axial direction and are arranged on the respective end faces of the inner and outer housings 20, 30, thus offering the greatest possible stability in the horizontal direction. This permits to counteract any tilting of the inner housing 20 relative to the outer housing 30, so that a rigid coupling is achieved in the horizontal direction.

A leaf spring package 34 comprises a plurality of leaf springs. Instead of leaf springs, other spring elements are also conceivable and possible, for example disk springs. The leaf spring packages 34 are arranged in such a way that they can be easily exchanged. For this purpose, a clamping ring 35 is provided on each end face, with allows to firmly and detachably connect the leaf spring packages 34 to the outer housing 30 and to thereby retain the leaf spring packages 34.

By exchanging the spring elements, the natural frequency of the vibration isolator 10 can be easily adjusted so that it can be adapted to various load situations. In particular, a natural frequency of more than 5 Hz can be achieved in order to obtain short settling times.

The coil spring 50 is coupled to the inner housing 20 in a mechanically rigid way in the horizontal direction and therefore provides isolation in the vertical direction. The inner housing 20 is designed to accommodate and support the coil spring 50 with appropriate means, in the example with a lower spring plate 24 which allows the coil spring 50 to be firmly seated in the horizontal and vertical directions. The spring plate 24 can be moved in the axial direction by an adjusting means 52 in order to adjust for the height.

According to the present disclosure, an actuator is provided, which is effective in the vertical direction and which is arranged in the working space of the vibration isolator and is designated as a whole by reference numerals 40, 40a. The actuator 40, 40a is in the form of a linear motor having a rectilinear path of movement and enables a particularly uniform introduction of force into the vibration isolator 10.

In this embodiment, the actuator 40, 40a comes in the form of a magnetic actuator, comprising coils 41, 41a and magnets 42, 42a, each forming a magnet-coil pair. Coil 41 and magnet 42 are arranged inside the working space 32 between the inner housing 20 and the outer housing 30 and form a magnet-coil pair. In the working space 32, recesses are formed in the inner wall of the outer housing 30 and/or recesses are formed in the outer wall of the inner housing 20, for accommodating the magnets 42 and coils 41, respectively. In this embodiment, the coils are pressed onto or glued to the outer wall of the inner housing 20. The inner housing 20 is made from a ferrous material, for example steel. The magnets 42 are inserted into and glued to precisely fitting complementary recesses on the inner wall of the outer housing 30.

The actuator 40, 40a thus provides additional vibration isolation in the vertical direction, parallel to the coil spring 50. The actuator 40, 40a represents the active component of the vibration isolator 10.

In the illustrated embodiment, a total of three magnet-coil pairs are provided, which completely surround the coil spring 50 and extend in the axial direction approximately along the length of the coil spring 50, which is a favorable arrangement with regard to a compact design of the vibration isolator 10 while simultaneously providing high stability.

In the illustrated embodiment, the magnet-coil pairs are ring-shaped. In this way, the coil spring 50 can be completely surrounded. This allows for a particularly even introduction of force through the actuator 40, 40a into the vibration isolator 10. In particular, this makes it possible to prevent the actuator 40, 40a from causing any tilting movement of the inner housing 20 as a result of an uneven one-sided introduction of force.

In the illustrated embodiment, the windings of the coils 41 of actuator 40, 40a extend around the outer wall of the inner housing 20. The associated magnet 42, in this embodiment a permanent magnet, is associated with the outer housing 30 and is arranged on the inner wall slightly spaced apart from the coil 41. Accordingly, the magnets 42 and the associated coils 41 are arranged so as to face each other, with a gap between magnet 42 and coil 41.

Due to the rigid coupling between the inner and outer housings 20, 30 in the horizontal direction, this gap is designed to be particularly narrow. In this embodiment, the gap has a width of less than 5 mm, for example less than 1 mm, and for instance less than 0.5 mm. This makes it possible, on the one hand, to design the working space 32 to be correspondingly small, so that the vibration isolator 10 can be kept compact overall. On the other hand, comparatively high forces can be generated. An inverted arrangement of magnet 42 and coil 41 is likewise possible and conceivable.

In the illustrated embodiment, the vibration isolator 10 comprises three actuators 40, 40a connected in parallel, in the example magnetic actuators or magnet-coil pairs, which are arranged next to one another in the axial direction. More generally, embodiments which comprise more than one actuator 40, 40a are possible and conceivable, for example two or even four or five or more actuators 40, 40a arranged next to one another, in particular magnetic actuators.

This allows to generate higher forces with a compact working space 32. In this case, the current flows in opposite directions through adjacent magnet-coil pairs. In an arrangement comprising three magnet-coil pairs, two axially spaced apart magnetic fields can therefore be formed.

In order to enable an even application of force over the length with an odd number of magnet-coil pairs, for example three or five magnet-coil pairs, the middle magnet-coil pair, designated with reference numeral 40a in the illustrated example, is dimensioned larger than the outer magnet-coil pairs or actuators 40 in order to enable the same or a higher application of force with the same current. For this purpose, the middle magnet-coil pair 40a comprising coil 4la and magnet 42a has twice the number of coil windings of the coil 41a compared to the two outer magnet-coil pairs. It is also possible to choose a different, in particular larger wire cross-section or a combination of a different wire cross-section and a different number of windings. The outer magnet-coil pairs have the same design in terms of performance parameters.

In the axial direction, adjacent magnet-coil pairs have a certain spacing from each other, which in this embodiment is between 1 and 5 mm. In order to reduce the spacings, a shielding intermediate piece 43 is provided between adjacent magnet-coil pairs in this embodiment.

In the illustrated embodiment, the vibration isolator 10 further comprises an elongated insert 25 which serves to support the load. A major portion of this insert 25 protrudes into the coil spring 50. At the upper end, the insert 25 is firmly connected to the inner housing 20.

The insert 25 comprises an upper seat for receiving the coil spring, in the example an upper spring plate 24. In another embodiment, the insert 25 may be formed as part of the inner housing 20, also together with the upper spring plate 24.

In the area that protrudes into the coil spring 50, the insert 25 is designed with an upwardly opening cavity, which serves to accommodate a load bearing means 53. The load bearing means 53 is arranged coaxially to the insert 25 and to the coil spring 50 and is firmly connected to a base portion of the insert 25 in the lower area of the cavity both in the axial and radial directions. The load bearing means 53 is therefore retained at the base of the insert. In the upper portion or at the upper end face of the insert 25, the load bearing means 53 is arranged freely in the horizontal direction in the cavity, so that it can move in the radial direction.

In this embodiment, the load bearing means 53 is in the form of a bending rod. At its upper end, it can be coupled to the load to be isolated. For this purpose, a further support 54 is provided in this embodiment. The load to be isolated is not shown in this view. A force acting in a horizontal direction on the load to be isolated can therefore be absorbed by the load bearing means 53.

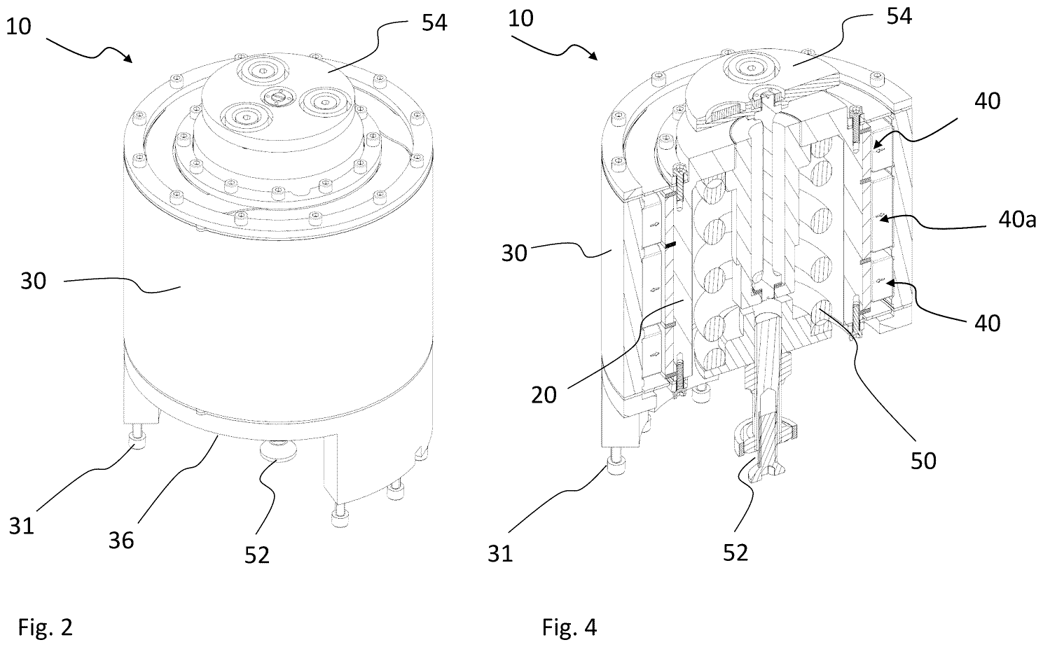

FIG. 2 shows the vibration isolator 10 in a perspective view. A lateral recess 36 makes it possible to adjust the height when the vibration isolator 10 is installed. The vibration isolator 10 has a total height of approximately 150 mm and a diameter of approximately 130 mm and is therefore very compact. The extension of the coil spring in the axial direction is approximately 90 mm. The total of three magnet-coil pairs are also distributed over approximately this distance, with the middle magnet-coil pair having approximately twice the extension in the axial direction as a respective outer magnet-coil pair. With these dimensions, a stroke of about 1.5 mm or even more is possible.

FIG. 4 shows the vibration isolator 10 of FIG. 2 in a perspective cross-sectional view.

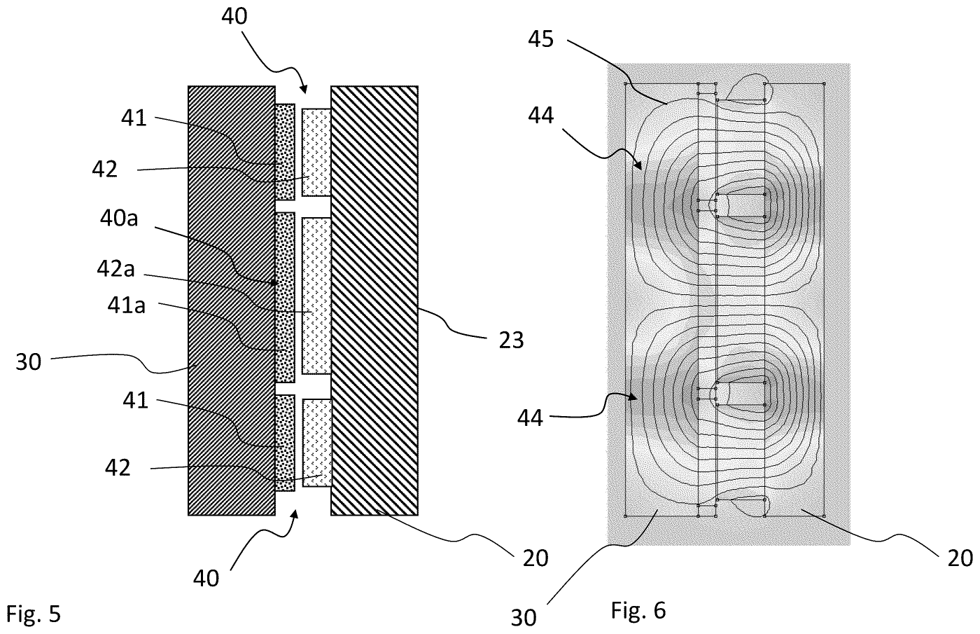

FIG. 5 shows a cross-sectional view of a section of the side wall of the inner and outer housings 20, 30 of the vibration isolator 10.

FIG. 6 shows a magnetic field arising during operation in this area of the side wall of the vibration isolator 10. As can be clearly seen, two magnetic fields 44 are formed, which are axially spaced apart from one another. In the cross-sectional view, the course of the magnetic lines is schematically indicated and labeled by reference numeral 45.

The present disclosure thus provides a method for isolating a load to be supported, e.g. a scanning electron microscope 5, a lithography device, or a lithography system, an optical inspection device, a system or device for handling wafers or substrates, or any other device or system which places particularly high demands on vibration isolation.

The present disclosure furthermore also encompasses a device, for example a lithography device or system, an optical inspection device, a system or device for handling wafers or substrates, which uses at least one vibration isolator 10 as described above.

1. A vibration isolator, comprising
an inner housing with a cavity tha receives and holds a coil spring arranged inside the cavity of the inner housing acts in a vertical direction;
an outer housing at least partially surrounding the inner housing; and
an actuator that acts in a vertical direction and is arranged between the inner housing and the outer housing.

2. The vibration isolator of claim 1, wherein at least one spring element is provided between the outer and inner housings, which enables an axial movement of the inner housing relative to the outer housing.

3. The vibration isolator of claim 2, wherein at least two leaf springs are provided, which are arranged spaced apart from one another in the axial direction.

4. The vibration isolator of claim 1, wherein the actuator is in the form of a magnetic actuator, comprising at least one coil and one magnet, which form a magnet-coil pair.

5. The vibration isolator of claim 4, wherein recesses are provided in a working space for accommodating the coil and/or the magnet of the magnetic actuator.

6. The vibration isolator of claim 4, wherein the magnet-coil pair surrounds the coil spring, at least sections thereof.

7. The vibration isolator of claim 4, wherein the magnet-coil pair is ring-shaped and completely surrounds the coil spring, at least sections thereof.

8. The vibration isolator of claim 1, wherein a plurality of actuators are provided, which are arranged next to one another in the axial direction.

9. The vibration isolator of claim 8, wherein the spacing between two adjacent magnet-coil pairs is between 1 and 5 mm.

10. The vibration isolator of claim 8, wherein the coil of at least one magnet-coil pair is arranged on an outer wall of the inner housing; and/or an associated magnet is arranged on the inner wall of the outer housing.

11. The vibration isolator of claim 8, wherein a gap is provided between the associated magnet and the coil of a magnet-coil pair, the gap having a width of less than 5 mm, preferably less than 1 mm, and most preferably less than 0.5 mm.

12. The vibration isolator of claim 1, further comprising an insert which protrudes at least partially into the coil spring.

13. The vibration isolator of claim 12, wherein the insert is coupled to a load bearing means which is firmly connected to the insert in the axial and radial directions.

14. The vibration isolator of claim 13,
wherein the load bearing means protrudes at least partially into the cavity of the insert;
and/or the load bearing means protrudes at least partially into the coil spring.

15. The vibration isolator of claim 13, wherein the load bearing means has its lower end coupled to a base of the insert and/or has its upper end coupled to a load to be isolated or to a load support.

16. The vibration isolator of any of claim 13, wherein the load bearing means is in the form of a bending rod or buckling pendulum.

17. The vibration isolator of claim 1, wherein the coil spring is coupled to the inner housing in a manner that is mechanically rigid in the horizontal direction.

18. A method for isolating a load to be supported, involving a vibration isolator according to claim1.

19. A device for handling wafers or substrates, comprising at least one vibration isolator according to claim 1.
